(19) United States
(12) Patent Application Publication
(10) Pub. No.: US 2015/0246421 A1
(43) Pub. Date: Sep. 3, 2015

(54) INTERFACE STRUCTURE

(71) Applicant: Almerino Canuto, Casale Sul Sile (IT)

(72) Inventor: Almerino Canuto, Casale Sul Sile (IT)

(21) Appl. No.: 14/431,388

(22) PCT Filed: Jun. 3, 2013
(86) PCT No.: PCT/EP2013/061355

§ 371 Date: Mar. 26, 2015

(30) Foreign Application Priority Data
Oct. 15, 2012 (IT) TV2012U000044

(51) Int. Cl. B23Q 3/10; B23Q 1/00

(52) U.S. Cl. CPC B23Q 3/103; B23Q 1/0081

(57) ABSTRACT

An interface structure for automatic locking systems for the mounting of blanks that are associable with a plate which can be associated with a base for supporting a T-shaped element which can move axially to an abutment which is integral with the base and the shank of which has balls that selectively protrude outside the abutment. The interface structure is constituted by a sleeve provided in a single body, which can be associated detachably and coaxially with the abutment. The sleeve is provided, axially to a first, lower end, with a first seat from which an annular ridge protrudes, provided with means for temporary fastening to the balls. The fastening means is adapted to determine the stable connection with the abutment. The sleeve includes, means for the jaw connection of a U-shaped toothed pivot proximate to a second, upper end, and the pivot is provided with a centering bush.

### FIELD

The present application relates to an interface structure.

### BACKGROUND

EP1346794B1 is known which relates to a modular structure, particularly for mounting blanks on retainers, which addresses the problem that arises when certain operations need to be carried out, such as for example painting, cleaning and assembly, or the execution of various forms of working, such as for example removing shavings, which require the locking of the piece and/or blank in a preset position for the treatment thereof.

Thus devices are known which are indispensable whenever the stable locking is required of an object to be treated by way of generic and even simple operations, not necessarily in a purely industrial setting.

A significant drawback, which is complained of in conventional devices, lies in the fact that in order to achieve a stable locking of the piece it is necessary to bring both of the spacing elements of the locking device in contact with two opposite side faces of the same piece.

In this manner the possibility is thus ruled out of executing any work at those side faces, which, since they are affected by the contact, have no free surfaces to allow contact with the tool or, more generally, with the component of any machine tool.

The necessity follows from this of subsequently removing the piece, positioning it according to a new orientation which is such as to allow the exposure of the two side surfaces which were before partially concealed by the locking elements.

A further aggravating factor of the above problem consists in that, during the locking of the piece, the latter has at least three surfaces at which no working can be done, the third surface, in addition to the side surfaces adjacent to the locking elements, being the lower one, which is entirely resting on the work surface of the machine tool.

The necessity follows from this of having to resort to multiple successive steps of positioning and associated locking of the piece, with the further aggravating factor of possibly repeatedly making systematic positioning errors, which thus have a negative effect on the precision that can be achieved overall at the end of working on the piece.

Another problem that is complained of in conventional devices lies in the necessity of availing of qualified labor in order to be able to perform the delicate preliminary operations of positioning and centering the piece.

An additional drawback, which often recurs in conventional locking devices, consists in the possibility of damaging the piece by local deformation, at the surfaces that have already been worked and are subsequently subjected to contact with the brackets, in order to allow the working of surfaces of the piece which have not yet been treated.

A significant problem, in addition to those mentioned above, relates to the considerable expenditure of time caused by repeated, successive operations to unlock, reposition and relock a piece that is intended to receive some form of treatment at multiple surfaces.

In a partial solution to such drawbacks, EP1346794B1 claims a modular structure, for mounting, on retainers, blanks having at least one seat, said modular structure comprising at least one flat plate that has a plurality of first seats for detachable connection of first fixing means for at least one first body and second temporary fixing means allowing detachable connection of said first body to said blank characterized in that said second temporary fixing means allow connection of said modular structure at said seat formed in said blank and in that it further comprises a first centering bush for the automatic centering of said first body with respect to said first seat, said first bush having a first portion which can be connected in said first seat and a second frustum-shaped upper portion which has an approximately frustum-shaped outer perimetric surface that protrudes above the plate once the connection between the first seat and the bush has been established, said second frustum-shaped upper portion having a lower surface directly in contact with an upper surface of said flat plate; said first means for fixing said first body to said plate comprise a first traction element for connection between said first seat and said first body and a first vise-like device, which is associated with said first body, so as to temporarily lock said first traction element; said first body, which is cylindrical, has a second axial hole for the partial containment of said first and/or second traction elements, and comprises, in a lower region, a third through hole that is formed radially and is meant to accommodate said first vise-like device, said third hole affecting said second axial hole approximately at right angles; said first vise-like device is constituted by a pair of first jaws, which can be accommodated inside said third hole and are arranged mirror-symmetrically in mutually diametrically opposite positions, and said first jaws, which are substantially cylindrical, are mutually associable by way of activation means, which are constituted by a first screw, which is arranged coaxially to a fourth hole and a fifth hole which are through holes and are formed axially along said pair of first jaws.

This solution, although solving the above-mentioned problems, also has drawbacks in that it has been found that in the parts to be fixed, and thus in the blanks (designated with 50 in EP1346794B1), a first threaded hole (designated with 36 in EP1346794B1) is obtained for a fixing element (such as a threaded shank, designated with 39a in EP1346794B1) and thus a first seat (designated with 34 in EP1346794B1) for a centering bush (designated with 37 in EP1346794B1): in the course of the production process of the part to be fixed, some working steps can cause the geometric shape of the piece to vary, since the first seat may subsequently be recentered with a greater size and in the best adapted position for the centering of the part (slightly shifted from the previous one).

It follows from this that the diameters of the first hole and of the first seat do not have the same axis.

The same applicant, in a partial solution to the above-mentioned problems, filed, on Nov. 7, 2012, Italian application no. TV2012A000129 relating to a device for compensating the misalignment in automatic locking systems for mounting, on retainers, blanks which have a first hole, for a fastening element, at the end of which a first seat for a centering bush is provided, characterized in that it is constituted by a box-like body composed of a T-shaped hollow body and by a U-shaped base which form an inner seat for a truncated pyramid shaped jacket, arranged coaxially to the shank of said hollow body and above a piston, having the capability to move transversely with respect to said shank, a traction element being slideably arrangeable in said shank of said hollow body and axially integral with said fixing element and with which said centering bush is coaxially associated in an upper region and can be arranged at said first seat which has a diameter that exceeds the diameter of said first fixing hole and is provided eccentrically with respect to the latter, said traction element selectively cooperating with spheres which can be accommodated inside adapted openings provided in said shank and inside adapted second seats which are provided on said jacket, between the head of said hollow body and said jacket elastically compressible elements being provided, means being present for allowing a temporary axial movement of said piston.

Such solution, differently from the known art explained in which there is a mechanical interconnection of the various components which are mutually axially arrangeable in a stable condition, makes it possible, thanks to the presence of the piston, to achieve an adjustment of the positioning through the use of pneumatic means which are allowed to perform an axial movement with respect to the various components.

Such solution has been provided in order to enable the fixing both of pieces and of pallets, which are handled in automated environments.

Although such two solutions make it possible to position and stably lock the pieces on the platform of any machine tool so as to perform the desired work, it has been found that the two solutions must be usable separately: the first for manually locking pieces and the second for automatically locking them.

The two solutions cannot be used in conjunction on the same platform, owing to their mechanical diversity, which makes them incompatible.

### SUMMARY

The aim of the present disclosure is therefore to resolve the above-mentioned technical problems, eliminating the drawbacks in the cited known art, by providing a disclosure that makes it possible to use, in conjunction and on the same platform, both of the solutions explained above for the purpose of performing the centering and the stable fixing of pieces to be worked on the platform of any machine tool while at the same time being able to vary both the height of positioning of the pieces and that of the pallets on which they are to be positioned.

Within this aim an object of the present disclosure is to provide a structure that, in addition to the foregoing characteristics, is also low-cost and can be made with usual and conventional machinery and plants.

This aim and these and other objects which will become more apparent hereinafter, are achieved by an interface structure for automatic locking systems for the mounting of blanks that are associable with a plate which can be associated with a base for supporting a T-shaped element which can move axially to an abutment which is integral with said base and the shank of which has balls that selectively protrude outside said abutment, characterized in that it is constituted by a sleeve, which is provided in a single body and can be associated detachably and coaxially with said abutment, and is provided, axially to a first, lower end, with a first seat from which an annular ridge protrudes, provided with temporary means of fastening with said balls, said temporary fastening means being adapted to determine the stable interconnection with said abutment, said sleeve having, axially to a second, upper end, means for the jaw connection of a U-shaped toothed pivot provided with a centering bush.

### BRIEF DESCRIPTION OF THE DRAWINGS

Further characteristics and advantages of the disclosure will become more apparent from the detailed description of a particular, but not exclusive, embodiment, illustrated by way of non-limiting example in the accompanying drawings wherein:

FIG. 1 is a partially sectional three-quarters view of the interface structure of the disclosure associated with the abutment which is integral with a plate for the mounting of blanks;

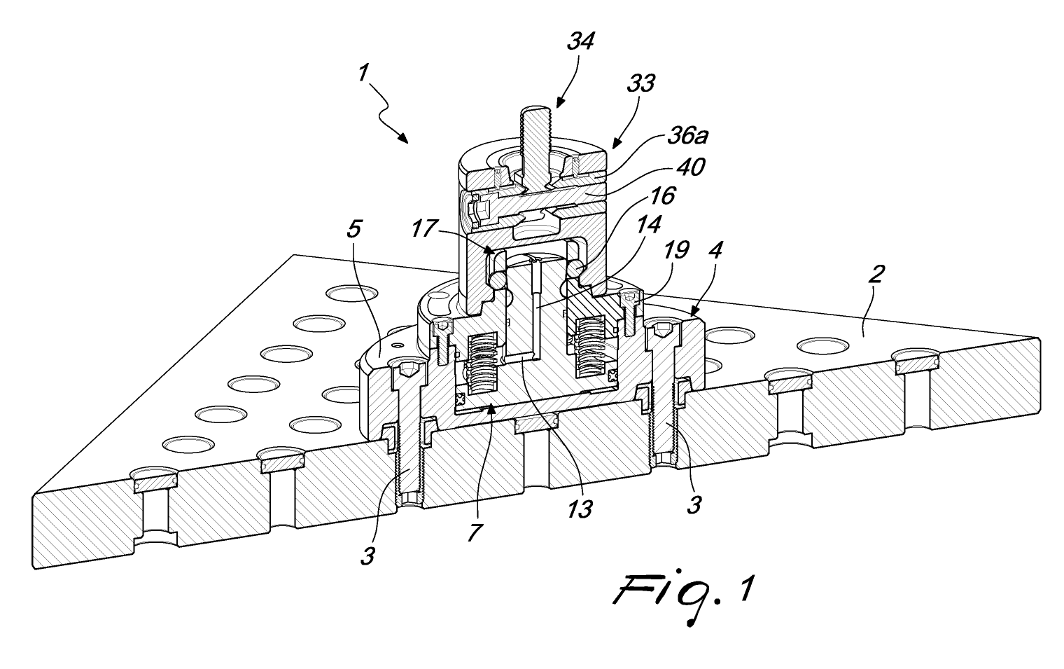

FIG. 2 is a diametrical sectional view of the interface structure of the disclosure of the previous figure in the condition of stable interconnection with said abutment;

FIG. 3 is a view similar to the previous figure of the interface structure of the disclosure in the condition of disconnection from said abutment;

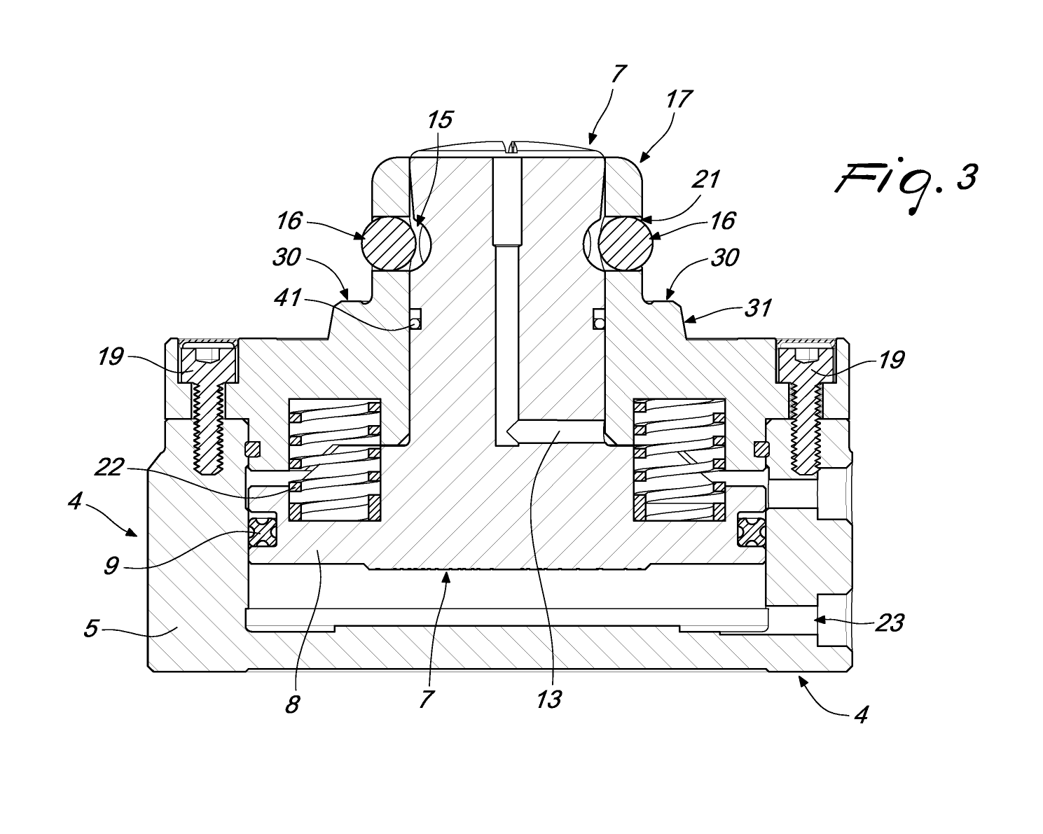

FIG. 4 is an exploded view of the interface structure of the disclosure and other components;

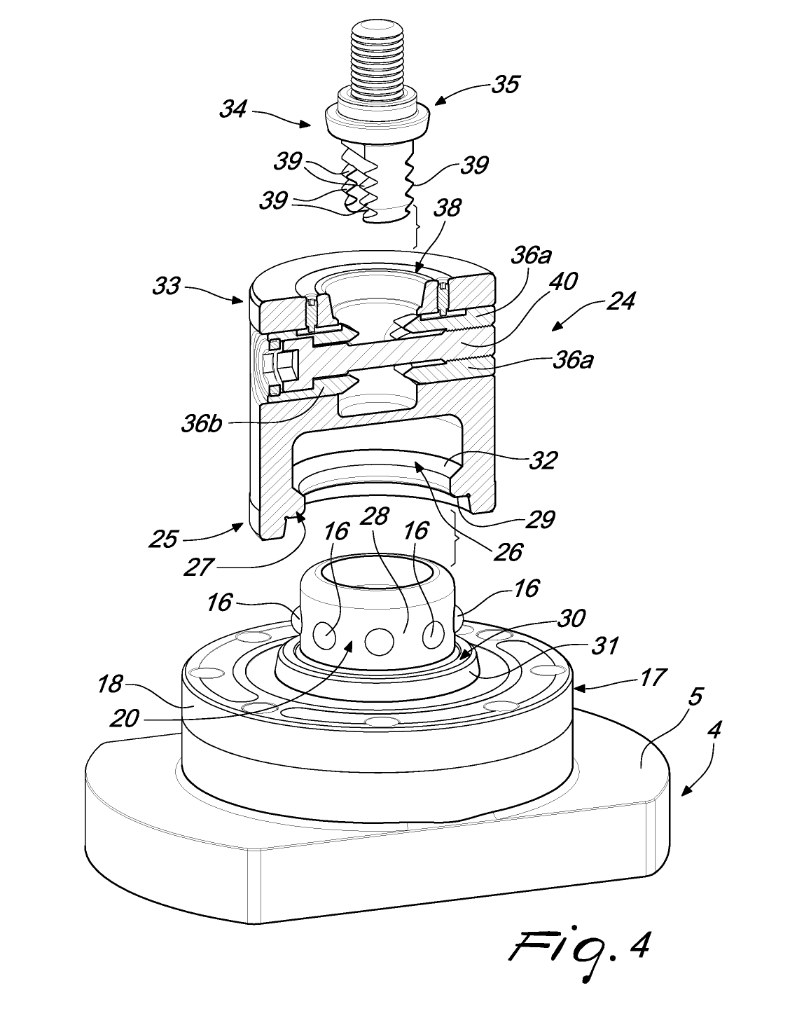

FIG. 5 is an exploded view of the supporting base, the T-shaped element, and the abutment.

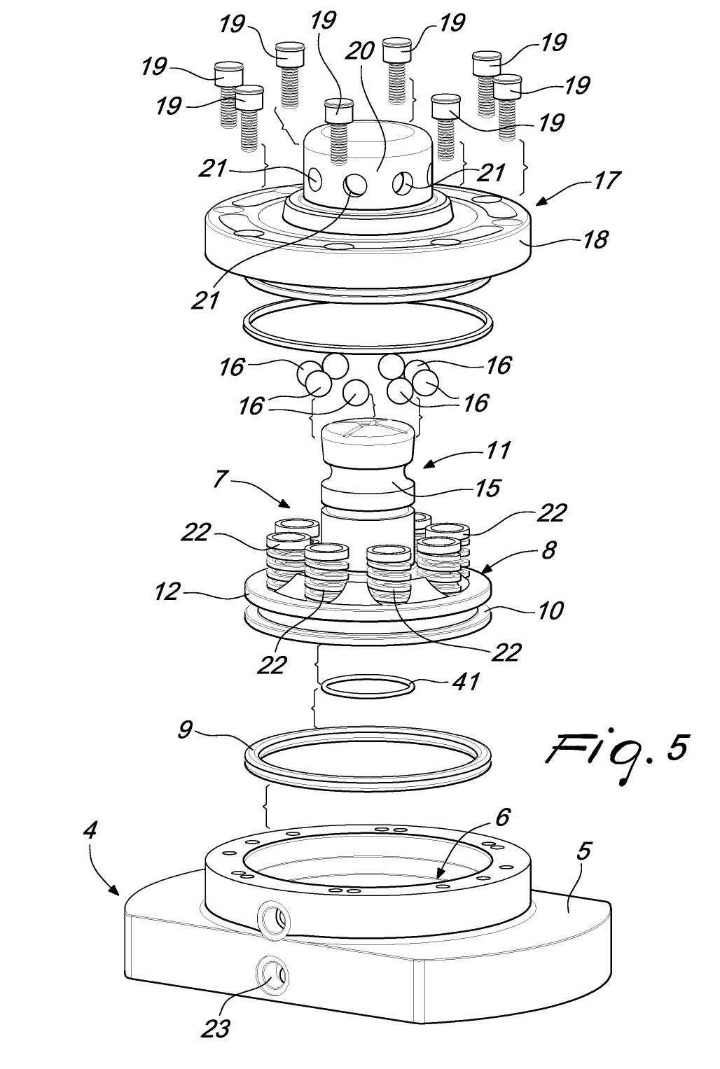

In the embodiments illustrated, individual characteristics shown in relation to specific examples may in reality be interchanged with other, different characteristics, existing in other embodiments.

### DETAILED DESCRIPTION OF THE DRAWINGS

With reference to the figures, the reference numeral 1 generally designates an interface structure for automatic locking systems for the mounting of blanks that are associable with a plate 2 with which it is possible to associate, by means of first screws 3, a base 4 comprising a first annular base 5, provided with adapted holes for the first screws 3, and an axial hollow 6 that accommodates and supports an element 7 shaped like an overturned T.

The latter has a head 8, which can be slideably engaged within the hollow 6 in contrast with a first sealing gasket 9 which is arranged at an adapted first seat 10 which is formed at the perimetric rim of the head 8.

The element 7 has moreover a shank 11 that is connected to the head 8 on an inclined plane 12.

Provided radially and axially to the shank 11 are a first pipe 13 and a second pipe 14, which are mutually connected, for the passage of air.

Proximate to the end tips of the shank 11 there is a second seat 15 for a plurality of balls 16 which can be partially accommodated within such seat 15.

The element 7 can move axially to an abutment 17 which is essentially shaped like an overturned T so as to form a second annular base 18 on which adapted holes for complementarily shaped second screws 19 are provided which are adapted to render the abutment 17 integral with the base 4.

Provided at the shank 20 of the abutment 17 are adapted openings 21 which are adapted to enable the partial exit of the balls 16 which thus cannot exit entirely.

The axial movement of the element 7 with respect to the abutment 17 occurs in contrast with adapted elastically compressible elements such as springs 22.

Such movement, moreover, is achieved by way of the injection of air through an adapted third pipe 23 which is formed radially to the first annular base 5, the third pipe 23 injecting air below the head 8 of the element 7.

The thrust to which the element 7 is subjected leads to the compression of the springs 22 which, once the pressure of the air has ceased, push the element 7 back into the hollow 6.

The interface structure 1 for automatic locking systems for the mounting of blanks is constituted by a sleeve 24, which is provided in a single body which can be associated detachably and coaxially with the abutment 17.

The sleeve 24 is provided, axially to a first, lower end 25, with a first seat or cavity 26 from which an annular ridge 27 radially protrudes which is of such size as to allow its axial movement with respect to the side surface 28 of the shank 11 of the element 7.

The annular ridge 27 is arranged, in the condition for stable coupling with the abutment 17, in a region facing the balls 16 that protrude from the shank 20 of the abutment 17, but slightly lowered with respect to them.

The depth of the first seat or cavity 26 is such as to allow the coupling, in the stable condition, with the shank 11 of the element 7.

The annular ridge 27 has a lower surface 29 which is shaped complementarily to the surface 30 of a projecting ridge 31 that protrudes from the second annular base 18 of the abutment 17 coaxially to the shank 20.

The annular ridge 27 is provided with means for temporary fastening to the balls, such means being adapted to determine the stable interconnection with the abutment 17.

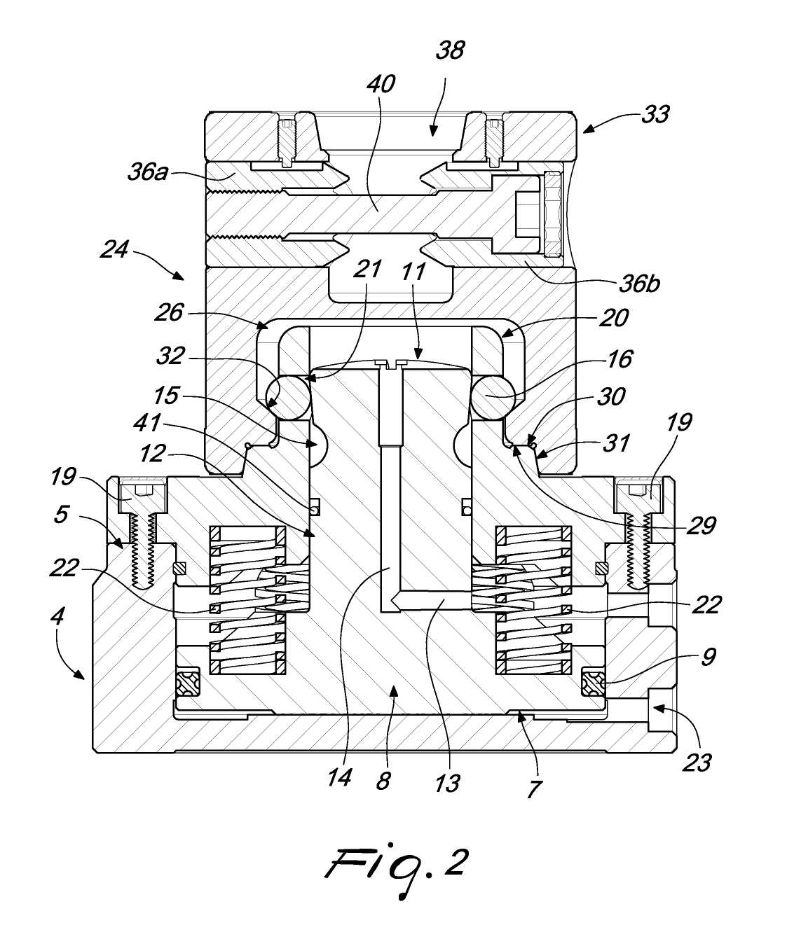

The means for temporary fastening are constituted by the upper surface 32 of the annular ridge 27, the upper surface having an inclined arrangement that interacts, in the condition of stable interconnection with the abutment 17 shown in FIG. 2, with a portion, underlying the diametrical plane, of the outer side surface of the various balls 16 which are forced to protrude outside the shank 20 of the abutment by the shank 11 of the element 7 pushed upward by the air injected through the third pipe 23.

In this condition the lower surface 29 of the annular ridge 27 is in abutment with the projecting ridge 31 protruding from the second annular base 18 of the abutment 17; the balls 16 thus generate a thrust, when they are forced outside the shank 20, which is discharged at the upper surface 32 of the annular ridge 27 thus achieving a clamping that renders the connection with the abutment 17 stable.

The sleeve 24 has, proximate to a second, upper end 33, means for the jaw connection of a U-shaped toothed pivot 34 which is provided with a centering bush 35.

The bush 35, which is of a conventional type, has a double taper which is adapted to enable an adaptation of the position of a manufactured article with respect to the position assumed by the pivot 34.

Said jaw coupling means are constituted by two barrels 36a and 36b which are slideably associable within adapted seats 37a and 37b which are provided transversely to the sleeve 24 and along the same axis so as to affect a second seat or cavity 38 which is provided axially to the sleeve and is adapted to accommodate a part of the toothed pivot 34.

The ends, which are mutually facing, of the two barrels 36a and 36b are contoured so as to interact selectively with some of the teeth that are present at the lower end of the toothed pivot 34.

The clamping of the two barrels 36a and 36b and therefore the locking of the toothed pivot 34 occur by means of an adapted third screw (40).

The seal of the element 7 with respect to the abutment 17 is made possible by the presence of a second gasket 41 arranged coaxially to the shank 11.

In practice it has been found that the disclosure has fully achieved the intended aim and objects, an interface structure having been obtained which can be used on the same platform, both for manually locking both pieces and pallets, and for achieving such locking automatically.

Naturally the materials used as well as the dimensions of the individual components of the disclosure may be more pertinent to specific requirements.

The various means of achieving certain different functions certainly need not coexist only in the embodiment shown, but may be present in many embodiments, even if they are not shown.

The characteristics indicated above as advantageous, convenient or the like, may also be missing or be substituted by equivalent characteristics.

The disclosures in Italian Utility Model Application No. TV2012U000044 from which this application claims priority are incorporated herein by reference.

1-9. (canceled)

10. An interface structure for automatic locking systems for the mounting of blanks that are associable with a plate which can be associated with a base for supporting a T-shaped element which can move axially to an abutment which is integral with said base and the shank of which has balls that selectively protrude outside said abutment, the interface structure being constituted by a sleeve, which is provided in a single body and can be associated detachably and coaxially with said abutment, and is provided, axially to a first, lower end, with a first seat from which an annular ridge protrudes, provided with means for temporary fastening to said balls, said fastening means being adapted to determine the stable connection with said abutment, said sleeve having, axially to a second, upper end, means for the jaw connection of a U-shaped toothed pivot provided with a centering bush.

11. The interface structure according to claim 10, wherein said annular ridge is of such size as to allow an axial movement of the annular ridge with respect to the side surface of said shank of said element.

12. The interface structure according to claim 10, wherein said base comprises a first annular base, provided with holes for first screws, and an axial hollow that accommodates and supports said element having an overturned T-shape which has a head which can be slideably associated within said hollow in contrast to a first sealing gasket arranged at a first seat formed at the perimetric rim of said head, said element being provided with a shank, which is connected to said head on an inclined plane, provided radially and axially to said shank being a first pipe and a second pipe, which are mutually connected, for the passage of air, in proximity to end tips of said shank a second seat being provided for a plurality of said balls which can be partially accommodated within said seat, said element being movable axially to said abutment and having an overturned T-shape so as to form a second annular base in which a plurality of holes are provided for complementary shaped second screws which are adapted to render said abutment integral with said base.

13. The interface structure according to claim 12, further including a plurality of openings at said shank of said abutment, the openings being adapted to allow a partial exit of said balls which cannot exit entirely, the axial movement of said element with respect to said abutment occurring in contrast to elastically compressible elements such as springs, said movement being achieved by way of injection of air through a third pipe which is provided radially to said first annular base, said third pipe injecting air below the head of said element, a thrust to which said element is subjected leading to the compression of said springs which, once a pressure of the air has ceased, push said element back into said hollow.

14. The interface structure according to claim 12, wherein said annular ridge is arranged, in a condition for stable coupling with said abutment, in a region facing said balls that protrude from said shank of the abutment but slightly lowered with respect the balls, a depth of said first seat or cavity configured to allow a coupling, in the stable condition, with said shank of said element, said annular ridge having a lower surface shaped complementary to a surface of a projecting ridge that protrudes from said second annular base of said abutment coaxially to said shank

15. The interface structure according to claim 10, wherein said annular ridge is provided with means for temporary fastening to said balls, which are adapted to determine the stable connection with said abutment, said means for temporary fastening being constituted by an upper surface of said annular ridge, said upper surface having an inclined arrangement that interacts, in the condition of stable connection with said abutment, with a portion, underlying the diametrical plane, of the outer side surface of said balls.

16. The interface structure according to claim 14, wherein said balls protrude outside said shank of said abutment by said shank of said element pushed upward by the air injected through said third pipe, wherein said lower surface of said annular ridge is in abutment with the projecting ridge that protrudes from said second annular base of said abutment, said balls generating a thrust, when they are forced outside said shank, which is discharged at the upper surface of said annular ridge and resulting in a clamping that renders the connection with said abutment stable.

17. The interface structure according to claim 10, wherein said sleeve further includes means for jaw coupling of a U-shaped toothed pivot proximate to a second, upper end, wherein the means for jaw coupling further includes a centering bush having a double taper adapted to enable an adaptation of a first position of a manufactured article with respect to a second position assumed by said pivot.

18. The interface structure according to claim 17, wherein said jaw coupling means are constituted by two barrels slideably associable within a plurality of adapted seats provided transversely to said sleeve and along the same axis so as to affect a second seat or cavity provided axially to the sleeve and adapted to accommodate a part of said toothed pivot, the ends, wherein the mutually facing ends of the two barrels are contoured so as to interact selectively with a plurality of teeth disposed at a lower end of said toothed pivot, clamping of the two barrels and locking of said toothed pivot occurring by means of a third screw.
